(19) United States
(12) Patent Application Publication
(10) Pub. No.: US 2026/0128472 A1
(43) Pub. Date: May 7, 2026

(54) COMPOSITE SEPARATOR AND ELECTROCHEMICAL DEVICE INCLUDING THE SAME

(71) Applicant: SK IE TECHNOLOGY CO., LTD., Seoul (KR)

(72) Inventors: Cheol Min YUN, Daejeon (KR); Dong Jae KIM, Daejeon (KR); Eun Ji OH, Daejeon (KR); Hee Joon JUNG, Daejeon (KR)

(21) Appl. No.: 19/382,141

(22) Filed: Nov. 6, 2025

(30) Foreign Application Priority Data
Nov. 7, 2024 (KR) 10-2024-0156768

(51) Int. Cl. H01M 50/451; H01M 50/417; H01M 50/434; H01M 50/443; H01M 50/489

(52) U.S. Cl. CPC H01M 50/451; H01M 50/417; H01M 50/434; H01M 50/443; H01M 50/489

(57) ABSTRACT

Composite separators and electrochemical devices including the composite separators are disclosed. In an embodiment, a composite separator include: a porous substrate; and a ceramic layer disposed on at least one surface of the substrate, the ceramic layer including inorganic particles and a binder, wherein the inorganic particles have an average particle diameter (D50) in a range of 0.20 μm to 0.40 μm and a ratio (A/B) of at least of 1.05, the ratio (A/B) being calculated between an area (A) on a small particle diameter side and an area (B) on a large particle diameter side based on a maximum peak in a particle size distribution diagram of the inorganic particles. The composite separator may exhibit excellent mechanical and thermal stability and excellent ion conduction properties.

### PRIORITY CLAIM AND CROSS-REFERENCE TO RELATED APPLICATIONS

This patent document claims the priority and benefits of Korean Patent Application No. 10-2024-0156768, filed on Nov. 7, 2024, the disclosure of which is incorporated herein by reference in its entirety.

### TECHNICAL FIELD

The disclosed technology relates to a composite separator and an electrochemical device including the same.

### BACKGROUND

In recent years, as electrochemical devices have gained greater capacity and output, there has been a growing demand for improved heat resistance and safety. In particular, the required performance of the separator, which is a very important component of electrochemical devices, has been advancing to meet these needs.

### SUMMARY

An embodiment of the disclosed technology provides a ceramic layer including: a porous substrate; and a ceramic layer disposed on at least one surface of the porous substrate and including pores formed between inorganic particles that are connected and fixed by a binder. The composite separator exhibits both excellent heat resistance and adhesive strength.

Another embodiment of the disclosed technology provides an electrochemical device that includes the composite separator to provide excellent battery performance and safety.

In one general aspect, a composite separator includes: a porous substrate; and a ceramic layer disposed on at least one surface of the substrate, the ceramic layer including inorganic particles and a binder, wherein the inorganic particles have an average particle diameter (D50) in a range of 0.20 μm to 0.40 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

In some embodiments, the inorganic particles may have a (D95−D50)/D50 value in a range of 1.8 to 2.5 in the particle size distribution diagram.

In some embodiments, the ratio (A/B) between the area (A) on the small particle diameter side and the area (B) on the large particle diameter may be in a range of 1.05 to 1.3 based on the maximum peak in the particle size distribution diagram of the inorganic particles.

In some embodiments, the binder may be included in an amount of 0.1 to 10 parts by weight relative to 100 parts by weight of the inorganic particles.

In some embodiments, the inorganic particles may include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

In some embodiments, the binder may include at least one of (meth)acryl-based polymers, fluorine-based polymers, styrene-based polymers, vinylalcohol-based polymers, vinylester-based polymers, vinylpyrrolidone-based polymers, cellulose-based polymers, polyimide-based polymers, polyamide-based polymers, polyalkylene glycol, or copolymers thereof.

In some embodiments, the binder may include polyacrylamide, carboxylmethyl cellulose, or a combination thereof.

In some embodiments, the binder may include carboxymethyl cellulose having a weight-average molecular weight of at least 180,000 and a degree of substitution in a range of 0.6 to 1.2.

In some embodiments, the porous substrate may be hydrophilically surface-treated to be hydrophilic.

In some embodiments, the ceramic layer may have a coating density in a range of 1.2 to 1.8 g/cm³.

In some embodiments, the ceramic layer may have a total thickness in a range of 0.5 μm to 10 μm.

In some embodiments, the composite separator may have a thickness in a range of 1 to 100 μm.

In some embodiments, when the composite separator is subjected to a cardboard test, a ratio of an area occupied by foreign matter smeared on a surface of a cardboard to a total area of the cardboard may be 5% or less:

Here, the cardboard test comprises: placing a black cardboard and a rubber pad having a size of 2 cm×10 cm sequentially on a ceramic layer of a composite separator specimen having a size of 5 cm×10 cm; pulling the cardboard horizontally at a speed of 0.1 m/s for a distance of 60 mm while applying a force of 10 N to the rubber pad using a pressing device; and evaluating a degree of foreign matter smeared on the surface of the cardboard.

In some embodiments, the composite separator may exhibit heat shrinkage rates in machine direction (MD) and transverse direction (TD) of 4% or less, wherein the heat shrinkage rates in MD and TD are measured after the composite separator is allowed to stand at 150° C. for 60 minutes.

In another general aspect, an electrochemical device includes: a positive electrode, a negative electrode, and a composite separator, wherein the composite separator includes: a porous substrate, and a ceramic layer disposed on at least one surface of the substrate, the ceramic layer including inorganic particles and a binder, wherein the inorganic particles have an average particle diameter (D50) in a range of 0.2 μm to 0.4 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

Other features and aspects will be apparent from the following detailed description, the drawings, and the claims.

### BRIEF DESCRIPTION OF THE DRAWINGS

FIG. 1 shows a cross section of an example of a composite separator of the disclosed technology.

FIG. 2 shows an example of a particle size distribution diagram of inorganic particles used in Example 1.

### DETAILED DESCRIPTION OF EMBODIMENTS

The numerical range used in some embodiments includes all values within the range including the lower limit and the upper limit, increments logically derived from the form and spanning of a defined range, all double limited values, and all possible combinations of the upper limit and the lower limit in the numerical range defined in different forms. Unless otherwise defined in the present specification, values which may be outside a numerical range due to experimental error or rounding off of a value are also included in the defined numerical range.

Unless otherwise particularly defined in embodiments, “about” may be considered as a value within 30%, 25%, 20%, 15%, 10%, or 5% of a stated value.

To enhance the heat resistance and safety of a separator of a battery, a composite separator is applied to a porous substrate and this composite separator includes a coating layer including inorganic particles such as alumina (Al₂O₃), silica (SiO₂), or zirconia (ZrO₂) and a binder. However, research is now focusing on thinning separators to achieve higher capacity and output in electrochemical devices, but it is difficult to maintain sufficient heat resistance of such a thin inorganic particle coating layer, In addition, when heat resistance of separators is improved, other properties such as adhesive strength and air permeability tend to deteriorate, leading to reduced device performance.

Hereinafter, the disclosed technology will be described in detail. However, it is only illustrative, and the disclosed technology is not limited to the specific example embodiment which is illustratively described.

In one example technology, inorganic particles having a specific minimum size are used to address a heat resistance degradation issues caused by the thinning of a composite separator including a porous substrate and an inorganic coating layer. Although this method provided some improvement in heat resistance, it reduced adhesive strength between inorganic particles and between inorganic particles and the substrate was reduced, and also deteriorated air permeability. Furthermore, when the adhesive strength and/or air permeability are improved, heat resistance again deteriorated.

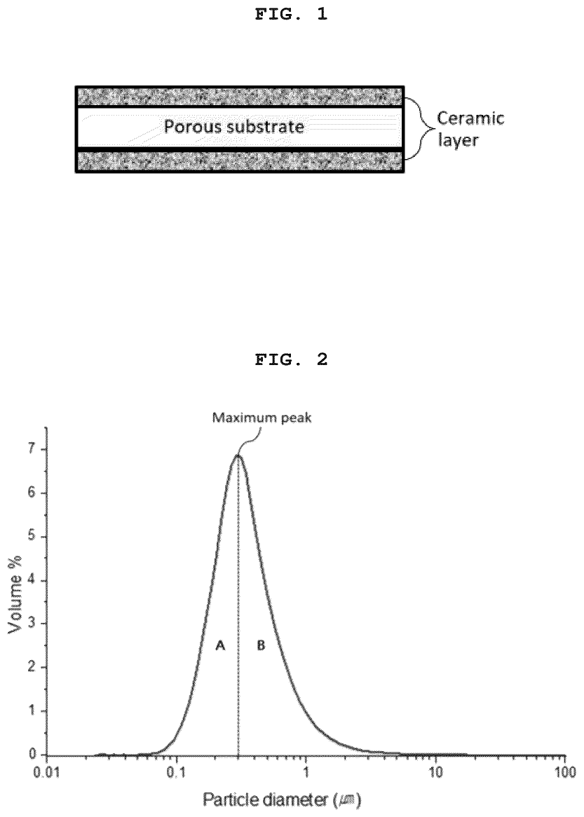

The disclosed technology can be implemented in some embodiments to address these issues by providing a composite separator that includes a porous substrate; and a ceramic layer disposed on at least one surface of the substrate, the ceramic layer including inorganic particles and a binder, thereby exhibiting improved heat resistance, adhesive strength, and air permeability characteristics simultaneously even in a thinned thickness range, when the inorganic particles has an average particle diameter in a specific range and a specific particle size distribution characteristics. FIG. 1 shows an example of a suitable structure of such a composite separator.

The disclosed technology provides a composite separator which may secure excellent mechanical and thermal stability and ion conduction properties simultaneously.

The composite separator based on an example embodiment includes: a porous substrate; and a ceramic layer disposed on at least one surface of the substrate, the ceramic layer including inorganic particles and a binder, wherein the inorganic particles have an average particle diameter (D50) in a range of 0.20 μm to 0.40 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

In some example embodiments, when the composite separator has a particle size distribution characteristics of a ratio (A/B) of at least of 1.05, the ratio (A/B) being calculated between an area (A) on a small particle diameter side and an area (B) on a large particle diameter side based on a maximum peak in a particle size distribution diagram of the inorganic particles while having an average particle diameter in a range of 0.20 μm to 0.40 μm, it exhibits excellent heat resistance. In addition, these properties are maintained even when the ceramic layer is formed with a very small thickness. As a result, an electrochemical device including this separator may simultaneously achieve safety, a high capacity, and high output characteristics.

In an example embodiment, the average particle diameter (D50) of the inorganic particles may refer to a particle diameter of inorganic particles corresponding to 50% as a volume-based cumulative fraction and may be calculated from a particle size distribution diagram measured in accordance with the standard of KA A ISO 13320-1.

In an example embodiment, the particle size distribution diagram may be a graph of volume percentage (vol %) depending on the particle diameter of inorganic particles. In an example embodiment, based on a particle size distribution diagram plotted in order of particle diameter from small to large from left to right of the x-axis, the area (A) on the small particle diameter side refers to an area from a starting point to the x-axis of the maximum peak, e.g., the area to the left of the maximum peak, and the area (B) on the large particle diameter side refers to an area from the x-axis of the maximum peak to the end point of the particle size distribution diagram, e.g., the area to the right of the maximum peak.

In an example embodiment, the ratio (A/B) between the area (A) of the small particle diameter side and the area (B) of the large particle diameter side may be in a range of 1.05 or more, 1.06 or more, 1.07 or more, 1.5 or less, 1.4 or less, 1.3 or less, or 1.2 or less, may be 1.05 to 1.5, 1.05 to 1.3, or 1.06 to 1.3, based on the maximum peak in the particle size distribution diagram of the inorganic particles and may include all possible combinations of the upper limits and the lower limits of the numerical ranges.

In an example embodiment, the inorganic particles may have a (D95−D50)/D50 value in a range of 1.5 or more, 1.7 or more, 1.8 or more, 3.0 or less, 2.8 or less, 2.6 or less, 2.5 or less, 2.4 or less, or 2.3 or less, may be 1.5 to 3.0, 1.8 to 3.0, or 1.8 to 2.8, or may include all possible combinations of the upper limits and the lower limits of the numerical ranges. When the inorganic particles having the average particle size and the A/B area ratio described above, and the (D95−D50)/D50 value, the adhesive strength, heat resistance, and air permeability are improved. In an example embodiment, the D95 refers to a particle diameter of inorganic particles corresponding to 95% in terms of a volume-based cumulative fraction.

In an example embodiment, any type of inorganic particles may be used without limitation as long as it satisfies the average particle size and the particle size distribution characteristics described above. As a non-limiting example, the inorganic particles may include one or more selected from metal oxides, metal hydroxide, metal carbides, metal nitrides, and metal carbonitrides, such as boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, and SiC. In some embodiments, the inorganic particles may include materials other than those listed above.

In an example embodiment, a coating density of the ceramic layer may be 1.0 g/cm³ or more, 1.1 g/cm³ or more, 1.2 g/cm³ or more, 2.0 g/cm³ or less, 1.9 g/cm³ or less, 1.8 g/cm³ or less, or 1.7 g/cm³ or less and may be 1.0 to 1.8 g/cm³ or 1.2 to 1.8 g/cm³.

In an example embodiment, a thickness of the composite separator may be 1 μm to 200 μm, 2 μm to 200 μm, 5 μm to 200 μm, 5 μm to 150 μm, 5 μm to 100 μm, 5 μm to 50 μm, 5 μm to 30 μm, or 5 μm to 20 μm, or may include all possible combinations of the upper limits and the lower limits of the numerical ranges, but the disclosed technology is not limited thereto.

In an example embodiment, the ceramic layer may be coated on one or two opposing surfaces of the porous substrate, and when the ceramic layer is coated on two opposing surfaces of the porous substrate, the thicknesses of the ceramic layer coated on one surface and the other surface may be the same as or different from each other. Although not particularly limited, the total thickness of the ceramic layer implemented based on an example embodiment may be, for example, 0.1 μm to 10.0 μm, 0.5 μm to 10.0 μm, 1 μm to 10 μm, 1 μm to 8 μm, 1 μm to 5 μm, about 1.5 μm to 5 μm, 2 μm to 5 μm, 2 μm to 4 μm, or a value between the numerical values. Since the composite separator based on an example embodiment may maintain excellent adhesive strength and heat resistance even when the ceramic layer is very thin, an electrochemical device employing the separator may satisfy safety, a high capacity, and high output characteristics simultaneously.

In an example embodiment, the ceramic layer may include 90 to 99.9 wt %, 92 to 99.5 wt %, 92 to 99 wt %, 95 to 99 wt %, or 96 to 99 wt % of the inorganic particles with respect to the total weight of the ceramic layer. When compared with the content of the inorganic particles in a conventional coating layer formed by connecting inorganic particles including the binder, the ceramic layer implemented based on some embodiments may include more inorganic particles may be included. Since heat resistance and numerical stability are excellent, the coating layer (ceramic layer) may be formed at a smaller thickness.

In an example embodiment, the ceramic layer may use the binder at 10 parts by weight or less, 8 parts by weight or less, 5 parts by weight or less, 3 parts by weight or less, 2 parts by weight or less, or 1 part by weight or less and 0.1 parts by weight or more, 0.5 parts by weight or more, 1 part by weight or more, 2 parts by weight or more, specifically 0.1 to 5 parts by weight, 1 to 5 parts by weight, or 1 to 3 parts by weight, with respect to 100 parts by weight of the inorganic particles, or at a content between the numerical ranges.

In an example embodiment, the binder is not particularly limited as long as it is a common binder used in the art, and as a non-limiting example, may be one or more selected from (meth)acryl-based polymers, fluorine-based polymers, styrene-based polymers, vinylalcohol-based polymers, vinylester-based polymers, vinylpyrrolidone-based polymers, cellulose-based polymers, polyimide-based polymers, polyamide-based polymers, polyalkylene glycol, copolymers thereof, and the like. The (meth)acryl-based polymer may be, as an example, selected from polyalkyl(meth)acrylate, poly(meth)acrylic acid, poly(meth)acrylamide, poly(meth)acrylonitrile, polyhydroxyethyl(meth)acrylate, copolymers thereof, or the like. The styrene-based polymer may be, as an example, selected from polystyrene, polyalphamethylstyrene, polybromostyrene, copolymers thereof, or the like. The vinylalcohol-based polymer may be, as an example, polyvinylalcohol or a copolymer including the same. The vinylester-based polymer may be, as an example, polyvinylalcohol or a copolymer including the same. The cellulose-based polymer may be, as an example, selected from cellulose, carboxymethyl cellulose, hydroxypropylmethyl cellulose, cellulose acetate, cellulose acetate propionate, or the like.

In an example embodiment, the binder may include a (meth)acryl-based polymer, a cellulose-based polymer, or combinations thereof.

Specifically, the binder may include polyacrylamide (PAAm), carboxymethyl cellulose, or a combination thereof, and specifically, may include a mixed binder of carboxymethyl cellulose and polyacrylamide, and this case may be preferred since an effect to be desired in the disclosed technology may be further improved, but the disclosed technology is not limited thereto.

In an example embodiment, when the binder includes polyacrylamide (PAAm), the weight-average molecular weight of the polyacrylamide may be 100,000 g/mol to 300,000 g/mol, 150,000 to 250,000 g/mol, or 200,000 to 250,000 g/moll, and may include all possible combinations of the upper limits and the lower limits of the numerical ranges, but is not limited thereto. The weight-average molecular weight may refer to a weight-average molecular weight converted with a molecular weight calibration curve using a polystyrene standard sample measured by a GPC method. The GPC method may be carried out at an ambient temperature, and the sample is prepared by dissolving CMC at a concentration of approximately 0.1% w/v in a standard reference solvent. The prepared solution is then injected into the GPC instrument for analysis.

In an example embodiment, when the binder includes carboxymethyl cellulose, the carboxymethyl cellulose may have the weight-average molecular weight of 180,000 to 1,500,000 g/mol, 180,000 to 1,300,000 g/mol, or 190,000 to 1,000,000 g/mol, and may include all possible combinations of the upper limits and the lower limits of the numerical ranges. In addition, the carboxymethyl cellulose may have a degree of substitution of 0.6 to 1.2, 0.6 to 1.1, 0.6 to 1.0, 0.7 to 1.0, 0.8 to 1.0, or 0.9 to 1.0, and may include all possible combinations of the upper limits and the lower limits of the numerical ranges. The weight-average molecular weight may refer to a weight-average molecular weight converted with a molecular weight calibration curve using a polysaccharide standard sample measured by a GPC method.

Herein, the carboxymethyl cellulose (CMC) refers to a cellulose derivative that is etherified by substituting a hydroxyl group (—OH) Herein, the with —OCH₂COOH and/or —OCH₂COO⁻M⁺ where M⁺ is an alkali metal cation and may be selected from lithium (Li), sodium (Na), potassium (K), rubidium (Rb), cesium (Cs), francium (Fr), and the like. In some embodiments, the term “degree of substitution (DS)” of carboxymethyl cellulose refers to the average number of the substituents present in one anhydrous glucose unit in a cellulose molecule. The DS value may be measured by a known or conventional method, and, for example, in accordance with ASTM D1439 and calculated by ¹H-NMR or ¹³C-NMR analysis.

The degree of substitution (DS) of carboxymethyl cellulose (CMC) was measured according to a titration method based on ASTM D1439. The experiment was carried out using a magnetic stirrer, aspirator, dry oven, 300 mL beaker, pipette, 250 mL Erlenmeyer flask, and Petri dish. The reagents used included 80% ethanol, 100% ethanol, 0.1 N sodium hydroxide (NaOH), phenolphthalein indicator, and 0.1 N sulfuric acid (H₂SO₄). Specifically, 150 mL of 80% ethanol was added to a 300 mL beaker, followed by 10 mL of 1 N nitric acid (HNO₃). Approximately 1-2 g of CMC sample was introduced into the beaker and stirred for 1 hour to convert the sodium salt form of CMC into the acid form (CMC-acid). After allowing the mixture to stand for about 10-20 minutes, the supernatant was decanted. Then, 150 mL of 80% ethanol was added again and stirred for 30-40 minutes, followed by decanting the supernatant once more. The precipitated CMC-acid was filtered using an aspirator and washed with 500 mL of 80% ethanol, followed by one or two washes with 100% ethanol. The central portion of the CMC-acid was collected in a clean weighing dish and dried in a dry oven for 20-30 minutes. After drying, approximately 0.2±0.05 g of the dried sample was weighed accurately, and 25 mL of 0.1 N NaOH solution was added. The sample solution was then transferred to a 250 mL Erlenmeyer flask containing 100 mL of distilled water and stirred for 40-60 minutes until completely dissolved. Two to three drops of phenolphthalein were added as an indicator, and the solution was titrated with 0.1 N H₂SO₄ while stirring until the color changed from red to colorless. The number of millimoles of CMC-acid per gram of dried sample (A) was determined according to the following equation:

$$A = \frac{( millimoles of CMC Acid )}{Sample dry weight ( g )}$$

The degree of substitution (DS) was then calculated from A using the following equation:

$$B ( D . S . value ) = \frac{162 \times A}{10 , 000 - 58 \times A} .$$

When the binder includes carboxymethyl cellulose and polyacrylamide, the carboxymethyl cellulose and the polyacrylamide may be used at a weight ratio of 10 to 50:90 to 50 or 10 to 40:90 to 60.

In an example embodiment, heat shrinkage rates in MD and TD directions of the composite separator, measured after the separator is allowed to stand at 150° C. for 60 minutes, may each be 5% or less, specifically 4% or less, 3% or less, 2.5% or less, 2.0% or less, or less than 2.0%.

In addition, in an example embodiment, when a degree of foreign matter smeared on the surface of a cardboard is evaluated after a cardboard test of the composite separator, a ratio of an area occupied by the smeared foreign matter to an area of the cardboard may be 5% or less, specifically less than 5%, less than 4%, less than 3%, less than 2%, or less than 1.5%.

The cardboard test method involves placing a black cardboard and a rubber pad having a size of 2 cm×10 cm sequentially on an upper surface of a ceramic layer of a composite separator specimen having a size of 5 cm×10 cm, and pulling out the cardboard horizontally at a speed of 0.1 m/s in a state of applying a force of 10 N to the rubber pad using a pressing device to evaluate an area as a degree of foreign matter smeared on the surface of the cardboard, in which the foreign matter may be the constituent components of the ceramic layer, for example, the inorganic particles, the binder, or a combination thereof.

When the adhesive strength is evaluated using the cardboard test method as described above, measurement may be performed considering adhesive strength between the inorganic particles in the ceramic layer as well as adhesive strength between interfaces of the substrate and the ceramic layer, and from the results of the adhesive strength test, a heat shrinkage degree may be predicted more accurately as compared with a conventional peel test. That is, when a ratio of an area occupied by the smeared foreign matter calculated by the cardboard test is less than 5%, less than 4%, less than 3%, less than 2%, or less than 1.5%, it means that adhesive strengths between the inorganic particles and between the inorganic particles and the substrate are all excellent, and the heat shrinkage phenomenon may be effectively suppressed.

As an example, a method such as a peeling test commonly used for evaluating adhesive strength of an inorganic particle coating layer in a composite separator can be used to evaluate adhesive strength between interfaces of the substrate and the inorganic particle coating layer. However it may be difficult to evaluate the adhesive strength between the inorganic particles is difficult to be predicted, and the heat shrinkage characteristics of the separator.

In an example embodiment, the porous substrate is not limited as long as it is commonly used in the art, and for example, may be a woven fabric, a non-woven fabric, or a porous film. Specifically, the porous substrate may be polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenyleneoxide, cyclic olefin copolymer, polyphenylenesulfide, polyethylenenaphthalate, glass fiber, teflon, and/or polytetrafluoroethylene, and any two or more of them may be used. Among the porous substrates, a porous film is manufactured by a dry method or a wet method known in the art.

In an example embodiment, the porous substrate may have a porosity of 20 to 60%, 30 to 60%, 30 to 50%, or 35 to 45%, but the disclosed technology is not limited thereto.

In an example embodiment, the porous substrate may have a polar functional group material introduced by performing a hydrophilic surface treatment to render the treated porous substrate to be hydrophilic or increase the affinity to water. In implementations, the polar functional group may be a carboxyl group, an aldehyde group, a hydroxyl group, or others, and the hydrophilic surface treatment may be, as an example, a corona discharge treatment or a plasma discharge treatment, but the disclosed technology is not limited thereto.

In an example embodiment, the thickness of the porous substrate is not particularly limited, and for example, may be 1 μm to 100 μm, 1 μm to 50 μm, 1 μm to 30 μm, 5 μm to 20 μm, or any value between the numerical values.

Another example embodiment of the disclosed technology provides an electrochemical device including the composite separator according to an example embodiment, and the electrochemical device may be, as an example, a lithium secondary battery.

Specifically, the electrochemical device based on an example embodiment includes a positive electrode, a negative electrode spaced from the positive electrode, and a composite separator between the positive and negative electrodes, and the composite separator includes: a porous substrate; and a ceramic layer disposed on at least one surface of the substrate, the ceramic layer including inorganic particles and a binder, wherein the inorganic particles have an average particle diameter (D50) in a range of 0.20 μm to 0.40 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

Hereinafter, the electrochemical device based on an example embodiment will be described using a lithium secondary battery as an example. In some embodiments, the electrochemical device may be manufactured with a structure known in the art using a common manufacturing method and common materials in the art, of course, except for including the composite separator implemented based on an example embodiment of the disclosed technology.

As an example, the lithium secondary battery may be manufactured using a common manufacturing method of placing a negative electrode, the composite separator, and a positive electrode sequentially, assembling them, and injecting an electrolyte to complete the battery.

### [Positive Electrode]

The positive electrode may include a positive electrode current collector and a positive electrode mixed layer on at least one surface of the positive electrode current collector, the positive electrode may be manufactured by forming the positive electrode mixed layer by applying a positive electrode material slurry on one or both surfaces of the positive electrode current collector, drying, and rolling, and the positive electrode material slurry may include a positive electrode active material and a binder, and if necessary, may further include a conductive material, a thickening agent, or others.

The positive electrode current collector may include a stainless steel, nickel, aluminum, titanium, or an alloy thereof, and may include aluminum or a stainless steel which is surface-treated with carbon, nickel, titanium, or silver. The thickness of the positive electrode current collector may be, for example, 10 μm to 50 μm, but the disclosed technology is not limited thereto.

The positive electrode active material is a compound capable of reversibly intercalating and deintercalating lithium ions and may be used without limitation as long as it is commonly used in the art, and as a non-limiting example, it may be a composite oxide of lithium with a metal selected from cobalt (Co), manganese (Mn), nickel (Ni), iron (Fe), niobium (Nb), magnesium (Mg), copper (Cu), zinc (Zn), molybdenum (Mo), tantalum (Ta), tungsten (W), aluminum (Al), or a combination thereof.

In an example embodiment, the positive electrode active material may be a lithium-nickel composite oxide, and the lithium-nickel composite oxide may further include one or more selected from cobalt, manganese, and aluminum. In some embodiments, the lithium-nickel composite oxide may include materials other than those listed above.

In an example embodiment, the positive electrode active material may include a lithium nickel-cobalt-manganese (NCM)-based composite oxide, and though the composition of the metal is not particularly limited, a high capacity (high-Ni) composition having a high nickel content may be used, and the content of Ni in the NCM-based lithium oxide (e.g., a mole fraction of nickel of the total moles of nickel, cobalt, and manganese) may be 0.3 or more, 0.4 or more, 0.5 or more, 0.6 or more, 0.7 or more, or 0.8 or more. In some example embodiments, the content of Ni may be 0.8 to 0.95, 0.82 to 0.95, 0.83 to 0.95, 0.84 to 0.95, 0.85 to 0.95, or 0.88 to 0.95. The NCM-based composite oxide may be, for example, LiNi_{0.33}Co_{0.33}Mn_{0.33}O₂, LiNi_{0.4}Co_{0.2}Mn_{0.4}O₂, LiNi_{0.5}Co_{0.2}Mn_{0.3}O₂, LiNi_{0.6}Co_{0.2}Mn_{0.2}O₂, LiNi_{0.7}Co_{0.15}Mn_{0.15}O₂, LiNi_{0.8}Co_{0.1}Mn_{0.1}O₂, and the like, but is not limited thereto.

In an example embodiment, the positive electrode active material may be, for example, lithium cobalt oxide-based, lithium manganese oxide-based, lithium nickel oxide-based, lithium iron phosphate-based (LFP, e.g., LiFePO₄), lithium manganese phosphate-based (e.g., LiMnPO₄), lithium cobalt phosphate-based (e.g., LiCoPO₄), lithium iron pyrophosphate-based (e.g., Li₂FeP₂O₇) materials, or others.

The positive electrode binder is not particularly limited as long as it is commonly used in the art. In some embodiments, the positive electrode binder may include a nonaqueous binder and/or an aqueous binder or include a rubber-based binder and/or a fluorine-based binder, and for example, may include one or more selected from acryl-based polymers such as polyacrylate, polymethacrylate, polybutylacrylate, and polyacrylonitrile, fluorine-based polymers such as polyvinylidene fluoride, polyhexafluoropropylene, polyvinylidene fluoride-hexafluoropropylene, and polyvinylidene fluoride-trichloroethylene, polyvinyl acetate, polyethylene oxide, cellulose, modified cellulose, polyamide, polyacrylamide, rubber, elastomer, or others, but the disclosed technology is not limited thereto. In some embodiments, the positive electrode binder may include materials other than those listed above.

The conductive material may be added for increasing conductivity of the positive electrode mixed layer and/or mobility of lithium ions or electrons. For example, the conductive material may be a linear conductive material and/or a dot-shaped conductive material, and for example, may include carbon-based conductive materials such as graphite, carbon black, acetylene black, ketjen black, graphene, carbon nanotubes, vapor-grown carbon fiber (VGCF), carbon fiber, and carbon nanofiber, and/or metal-based conductive materials including tin, tin oxide, titanium oxide, perovskite materials such as LaSrCoO₃ and LaSrMnO₃, or others, but the disclosed technology is not limited thereto. As used herein, the term “dot-shaped conductive material” refers to a general spherical or particulate form of conductive material.

### [Negative Electrode]

The negative electrode may include a negative electrode current collector and a negative electrode mixed layer on at least one surface of the negative electrode current collector, the positive electrode may be manufactured by forming the negative electrode mixed layer by applying a negative electrode material slurry on one or both surfaces of the positive electrode current collector, drying, and rolling, and the negative electrode material slurry may include a negative electrode active material and a binder, and if necessary, may further include a conductive material, a thickening agent, or others.

The negative electrode current collector may include a copper foil, a nickel foil, a stainless steel foil, a titanium foil, a nickel foam, a copper foam, a polymer substrate coated with a conductive metal, and the like. A thickness of the negative electrode current collector may be, for example, 10 μm to 50 μm, but is not limited thereto.

The negative electrode active material is a material capable of adsorbing and desorbing lithium ions and may be used without limitation as long as it is commonly used in the art, and as a non-limiting example thereof, carbon-based materials such as crystalline carbon, amorphous carbon, a carbon composite, and carbon fiber; lithium metal; lithium alloy; silicon (Si)-containing materials, tin (Sn)-containing materials, or others may be used.

An example of the amorphous carbon may include hard carbon, soft carbon, coke, mesocarbon microbeads (MCMB), mesophase pitch-based carbon fibers (MPCF), and the like, and an example of the crystalline carbon may include graphite-based carbon such as natural graphite, artificial graphite, graphitized coke, graphitized MCMB, and graphitized MPCF.

An element included in the lithium alloy may include aluminum, zinc, bismuth, cadmium, antimony, silicon, lead, tin, gallium, indium, or others.

The silicon-containing material may provide more increased capacity characteristics. The silicon-containing material may include Si, SiOₓ (0<x≤2), metal-doped SiOₓ (0<x≤2), a silicon-carbon composite, or others, the metal may include lithium and/or magnesium, and the metal-doped SiOₓ (0<x≤2) may include a metal silicate. The materials described above which may be used in manufacture of the positive electrode may be used as the binder, the conductive material, and the thickening agent of the negative electrode.

The negative electrode binder is not particularly limited as long as it is commonly used in the art, and may be rubber-based binders such as a styrene-butadiene rubber (SBR)-based binder, carboxymethyl cellulose (CMC), polyacrylic acid, poly(3,4 ethylenedioxythiophene) (PEDOT)-based binders, and the like.

### [Electrolyte]

In an example embodiment, the electrolyte may be a nonaqueous electrolytic solution, and the nonaqueous electrolytic solution may include a lithium salt as an electrolyte and an organic solvent.

The lithium salt is represented by, for example, Li⁺X⁻, and an anion of the lithium salt (X⁻) may be exemplified by F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻ or others.

The organic solvent sufficiently dissolves the lithium salt and the additive and may include an organic compound having no reactivity in a battery. The organic solvent may include, for example, at least one of carbonate-based solvents, ester-based solvents, ether-based solvents, ketone-based solvents, alcohol-based solvents, and aprotic solvents. The organic solvent may be, for example, one or more selected from propylene carbonate, ethylene carbonate, butylene carbonate, diethyl carbonate, dimethyl carbonate, ethyl methyl carbonate, methylpropyl carbonate, ethylpropyl carbonate, dipropyl carbonate, vinylene carbonate, methyl acetate, ethyl acetate, n-propyl acetate, 1,1-dimethylethyl acetate, methyl propionate, ethyl propionate, fluoroethyl acetate, difluoroethyl acetate, trifluoroethyl acetate, dibutylether, tetraethylene glycol dimethylether, diethylene glycol dimethylether, dimethoxyethane, tetrahydrofuran, 2-methyltetrahydrofuran, ethyl alcohol, isopropyl alcohol, dimethylsulfuroxide, acetonitrile, diethoxyethane, sulfolane, γ-butyrolactone, propylene sulfite, or others.

Hereinafter, the example embodiments described above will be described in detail through the following examples. However, the following examples are only for description, and do not limit the scope of a right.

### [Method for Measuring Physical Properties]

### 1) Particle Size of Inorganic Particles

A sample was collected in accordance with the standard of KS A ISO 13320-1, the particle size distribution was analyzed using S3500 available from MICROTRAC, and a particle size distribution diagram of volume % in accordance with the particle diameter was obtained. The particle diameter (Dn) of particles corresponding to n % as a volume-based cumulative fraction (n % of the particles have diameters that are less than the diameter Dn) was derived from the particle size distribution diagram, and the particle diameter of the sample particles to be measured corresponding to 50% as the volume-based cumulative fraction was set as an average particle diameter (D50) (i.e., 50% of the particles have diameters that are less than the diameter D50).

In addition, the area (A) of a small particle diameter side and the area (B) of a large particle diameter side were obtained based on the maximum peak of the particle size distribution diagram obtained by the above method. Specifically, in the particle size distribution diagram drawn in order of particle diameter from small to large from left to right of the x-axis as in FIG. 2, the area from the starting point of the particle size distribution diagram to the x-axis of the maximum peak was set as A, and the area from the x-axis of the maximum peak to the end point of the particle size distribution diagram was set as B.

### 2) Thickness

A composite separator was laminated in 10 layers, the thickness was measured at ambient temperature and atmospheric pressure by Mitutoyo (ID-C112X) to derive an average thickness of the 10 layers of the composite separator, and the average thickness was divided by 10 again to determine the thickness of the composite separator. A value obtained by subtracting the thickness of a porous substrate from the thickness of the composite separator was set as the total thickness of the ceramic layer.

The thickness of the porous substrate was obtained by laminating only the porous substrate in 10 layers, measuring the thickness by Mitutoyo (ID-C112X) to derive the average thickness of the 10 layers, and dividing the average thickness by 10. In the case of after forming the ceramic layer, the ceramic layer was detached, sufficient drying was performed, and the average thickness of the porous substrate from which the ceramic layer was detached was derived by the method described above.

### 3) Coating Density of Ceramic Layer

The coating density of the ceramic layer was calculated by the following equation, and the weight of the ceramic layer was set as a value obtained by subtracting the weight of the porous substrate from the weight of the composite separator. The composite separator was cut into a size of 100 mm×100 mm, two sheets overlapped, the weight was measured 5 times to determine the average weight of the two sheets of the composite separator, the average weight was divided again by 2 to determine the weight of the composite separator, and the weight of the porous substrate was determined by the same method as the method for measuring the weight of the composite separator using only the porous substrate cut into the size of 100 mm×100 mm.

$$Coating density of ceramic layer = ( weight of ceramic layer / thickness of ceramic layer ) / area$$

### 4) Adhesive Strength

### [Cardboard Test]

A composite separator was cut into a size of 5 cm×10 cm to prepare a specimen, and a black cardboard and a rubber pad having a size of 2 cm×10 cm were placed sequentially on the ceramic layer of the composite separator specimen. The cardboard was pulled out horizontally at a speed of 0.1 m/s for a distance of 60 mm in a state of applying a force of 10 N to the rubber pad using a pressing device, adhesive strength was evaluated depending on a degree of foreign matter smeared on the surface of the cardboard, and the foreign matter may be constituent components of the ceramic layer, for example, inorganic particles, a binder, or a combination thereof.

### [Evaluation of Degree of Smeared Foreign Matter]

After the cardboard test, the surface of the cardboard was photographed with an optical camera and imaged, and an area of the smeared foreign matter was measured. Specifically, an indirect lighting was installed with an LED lamp in the visible light range having a 60° slope, and the cardboard was photographed with a 640 M pixel optical camera at a height of 40 cm from the sample (cardboard). The photographed cardboard image was loaded with an Image J program, only an area through which the separator and the rubber pad were passed was selected and cut using a crop function, an image file format of the cut area was converted into a 8 bit image, and a Sharpen filter was applied to the image to adjust the brightness and the contrast of the image so that it is easy to distinguish between the cardboard and white foreign matter. A threshold was applied to the image to convert it into a binary image, an Analyze Particles function was executed to calculate a ratio of an area occupied by white foreign matter to the total area, and adhesive strength was evaluated based on the following criteria:

$$\begin{matrix}A : \text{<1.5} \% \\ B : 1.5 \% - 5 \% \\ C : \text{>5} \%\end{matrix}$$

### 5) Heat Shrinkage Rate

The heat shrinkage rate of the composite separator was measured based on the ASTM D1204 standard, but the following method was used. Lattice points were marked at 2 cm intervals on a square with one side of 10 cm on the composite separator specimen, and one side of the square was the transverse direction (TD) and the other one was the machine direction (MD). The specimen was placed right in the center, 5 sheets of paper were placed on and under the specimen, respectively, the four sides of the paper were taped, and the taped specimen was allowed to stand in a hot air drying oven at 150° C. for 60 minutes. Thereafter, the specimen was taken out, and the separator was observed with a camera to calculate the shrinkage rate in the machine direction (MD) and the shrinkage rate in the transverse direction (MD), which are shown in the following Table 2.

$$\begin{matrix}MD heat shrinkage rate ( \% ) = ( length in MD before heating - length in MD after heating ) / length in MD before heating \times 100 \\ TD heat shrinkage rate ( \% ) = ( length in TD before heating - length in TD after heating ) / length in TD before heating \times 100\end{matrix}$$

### Example 1

2 parts by weight of 1,2-benzisothiazolin-3-one (DIO2) as a dispersing agent was mixed with 100 parts by weight of boehmite (D95:0.61 μm, A/B:1.07) having an average particle diameter (D50) of 0.21 μm in water to prepare a slurry having a solid content of 45 wt %. The thus prepared slurry and carboxymethyl cellulose (CMC) having a degree of substitution of 0.9 and a weight-average molecular weight of 200,000 g/mol were mixed so that CMC was 3 parts by weight with respect to 100 parts by weight of the boehmite, and the mixture was diluted with water so that the solid content was 25 wt % to prepare a composition for forming a ceramic layer.

Both surfaces of a polyethylene film having a thickness of 9 μm (porosity: 35%-45%, SKIET) were corona discharged (power density: 2 W/m²) to introduce a surface polar group, and the corona surface treatment at this time was performed at a speed of 5 (meter per minute). The composition for forming a ceramic layer was applied on both surfaces of the corona surface-treated polyethylene film, bar-coated, and dried at 50° C. to manufacture a composite separator having ceramic layers at the same thickness formed on both surfaces.

### Example 2

The process was performed in the same manner as in Example 1, except that boehmite (D95:0.99 μm, A/B:1.17) having an average particle diameter (D50) of 0.30 μm was used.

### Example 3

The process was performed in the same manner as in Example 1, except that boehmite (D95:1.13 μm, A/B:1.12) having an average particle diameter (D50) of 0.37 μm was used.

### Example 4

The process was performed in the same manner as in Example 1, except that a mixture of carboxymethyl cellulose (CMC) having a degree of substitution of 0.9 and a weight-average molecular weight of 200,000 g/mol and polyacrylamide (PAAm) (Mw 200,000 g/mol, sigma aldrich) mixed at a weight of 10:90 was used as the binder.

### Example 5

The process was performed in the same manner as in Example 4, except that boehmite (D95:0.99 μm, A/B:1.17) having an average particle diameter (D50) of 0.30 μm was used.

### Example 6

The process was performed in the same manner as in Example 4, except that boehmite (D95:1.13 μm, A/B:1.12) having an average particle diameter (D50) of 0.37 μm was used.

### Example 7

The process was performed in the same manner as in Example 4, except that boehmite (D95:0.87 μm, A/B:1.09) having an average particle diameter (D50) of 0.32 μm was used.

### Comparative Example 1

The process was performed in the same manner as in Example 1, except that boehmite (D95:1.50 μm, A/B:1.09) having an average particle diameter (D50) of 0.50 μm was used.

### Comparative Example 2

The process was performed in the same manner as in Example 1, except that boehmite (D95:1.75 μm, A/B:0.97) having an average particle diameter (D50) of 0.64 μm was used.

### Comparative Example 3

The process was performed in the same manner as in Example 1, except that boehmite (D95:0.31 μm, A/B:1.15) having an average particle diameter (D50) of 0.10 μm was used.

### Comparative Example 4

The process was performed in the same manner as in Example 1, except that boehmite (D95:0.77 μm, A/B:1.04) having an average particle diameter (D50) of 0.27 μm was used.

### Comparative Example 5

The process was performed in the same manner as in Example 1, except that boehmite (D95:0.91 μm, A/B:1.02) having an average particle diameter (D50) of 0.38 μm was used.

TABLE 1

Particle size of inorganic particles

| | D50 (μm) | (D95 − D50)/D50 | A/B |
|---|---|---|---|
| Example 1 | 0.21 | 1.90 | 1.07 |
| Example 2 | 0.30 | 2.30 | 1.17 |
| Example 3 | 0.37 | 2.05 | 1.12 |
| Example 4 | 0.21 | 1.90 | 1.07 |
| Example 5 | 0.30 | 2.30 | 1.17 |
| Example 6 | 0.37 | 2.05 | 1.12 |
| Example 7 | 0.32 | 1.72 | 1.09 |
| Comparative | 0.50 | 2.00 | 1.09 |
| Example 1 | | | |
| Comparative | 0.64 | 1.73 | 0.97 |
| Example 2 | | | |
| Comparative | 0.10 | 2.1 | 1.15 |
| Example 3 | | | |
| Comparative | 0.27 | 1.85 | 1.04 |
| Example 4 | | | |
| Comparative | 0.38 | 1.39 | 1.02 |
| Example 5 | | | |

TABLE 2

| | Total | | | | |
|---|---|---|---|---|---|
| | thickness | Coating | | Heat shrinkage rate | |
| | (μm) of | density | Adhesive | (%) | |
| | ceramic layer | (g/cm³) | strength | MD | TD |
| Example 1 | 2.1 | 1.2792 | B | 1.9 | 1.5 |
| Example 2 | 2.2 | 1.3404 | A | 1.8 | 1.5 |
| Example 3 | 2.1 | 1.3892 | A | 1.5 | 1.3 |
| Example 4 | 2.1 | 1.5884 | B | 1.9 | 1.5 |
| Example 5 | 2.2 | 1.6659 | B | 2.0 | 1.0 |
| Example 6 | 2.1 | 1.6990 | A | 1.8 | 1.0 |
| Example 7 | 2.1 | 1.2610 | B | 2.4 | 2.0 |
| Comparative | 2.1 | 1.1342 | A | 15 | 14 |
| Example 1 | | | | | |
| Comparative | 2.2 | 0.6633 | A | 45 | 40 |
| Example 2 | | | | | |
| Comparative | 2.1 | 1.2432 | C | 50 | 49 |
| Example 3 | | | | | |
| Comparative | 2.2 | 1.2653 | C | 7.2 | 6.2 |
| Example 4 | | | | | |
| Comparative | 2.1 | 1.1680 | B | 8.0 | 9.2 |
| Example 5 | | | | | |

Referring to Table 1, the composite separator implemented based on an example embodiment of the disclosed technology exhibited excellent adhesive strength both between inorganic particles in the ceramic layer and between the substrate and ceramic layer interfaces, exhibited excellent heat resistance, and effectively suppressed a heat shrinkage phenomenon. An electrochemical device employing the composite separator implemented based on an example embodiment may achieve improved heat resistance and safety, while supporting higher capacity and output.

In contrast, the composite separators of the comparative example, which used inorganic particles outside the average particle diameter (D50) range of 0.20 μm to 0.40 μm or had the ratio (A/B) of less than 1.05 (the ratio (A/B) being calculated between the area (A) of the small particle diameter side and the area (B) of the large particle diameter side based on the maximum peak of the particle size distribution diagram) exhibited greatly reduced adhesive strength and heat shrinkage rates.

As can be seen from Tables 1 and 2, when the average particle diameter (D50) of the inorganic particles was within the range of 0.20 μm to 0.40 μm and the ratio (A/B) was 1.05 or a higher ratio simultaneously, the composite separator exhibited both excellent adhesion between the ceramic layer and the substrate and effective suppression of heat shrinkage in both MD and TD directions. In contrast, outside these ranges, at least one of the adhesion or heat shrinkage properties was significantly deteriorated, indicating that the combination of the average particle diameter D50 (in a range of 0.20 μm to 0.40 μm) and the A/B ratio (at least 1.05) provides an improvement in overall separator performance.

The composite separator of the disclosed technology may be widely applied to a green technology field such as electric vehicles, battery charging stations, and other solar power generations and wind power generations using batteries. In addition, the separator of the disclosed technology may be used in eco-friendly electric vehicles, hybrid vehicles, or others for preventing climate change by suppressing air pollution and greenhouse gas emissions.

The composite separator based on an example embodiment may exhibit excellent mechanical and thermal stability and ion conduction properties. Specifically, the composite separator based on an example embodiment includes a porous substrate and a ceramic layer including pores formed between inorganic particles that are connected and fixed by a binder. The composite separator may maintain excellent heat resistance even when the ceramic layer is formed with a very small thickness and exhibits excellent adhesive strength both between the inorganic particles and between the inorganic particles and the substrate, thereby effectively suppressing desorption of inorganic particles and shrinkage at a high temperature. Simultaneously, the composite separator based on an example embodiment may also provide excellent air permeability and ion conduction properties.

The electrochemical device employing the composite separator based on an example embodiment may simultaneously meet the required safety, high capacity, and high output characteristics.

Hereinabove, although the disclosed technology has been described by the specific matters and limited example embodiments in the disclosed technology, they have been provided only for assisting the entire understanding of the disclosed technology, and the disclosed technology is not limited to the example embodiments, and various modifications and changes may be made by those skilled in the art to which the disclosed technology pertains from the description.

Therefore, the disclosed technology is not limited to the above-described example embodiments, and the following claims as well as all modifications equal or equivalent to the claims are intended to fall within the scope of the disclosure.

What is claimed is:

1. A composite separator comprising:
a porous substrate; and
a ceramic layer disposed on at least one surface of the substrate, the ceramic layer including inorganic particles and a binder,
wherein the inorganic particles have an average particle diameter (D50) in a range of 0.20 μm to 0.40 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

2. The composite separator of claim 1, wherein the inorganic particles have a (D95−D50)/D50 value in a range of 1.8 to 2.5 in the particle size distribution diagram.

3. The composite separator of claim 1, wherein the ratio (A/B) is in a range of 1.05 to 1.3 based on the maximum peak in the particle size distribution diagram of the inorganic particles.

4. The composite separator of claim 1, wherein the binder is included in an amount of 0.1 to 10 parts by weight relative to 100 parts by weight of the inorganic particles.

5. The composite separator of claim 1, wherein the inorganic particles include at least one of boehmite, BaSO₄, CeO₂, MgO, CaO, ZnO, Al₂O₃, TiO₂, BaTiO₃, HfO₂, SrTiO₃, SnO₂, NiO, ZrO₂, Y₂O₃, or SiC.

6. The composite separator of claim 1, wherein the binder includes at least one of (meth)acryl-based polymers, fluorine-based polymers, styrene-based polymers, vinylalcohol-based polymers, vinylester-based polymers, vinylpyrrolidone-based polymers, cellulose-based polymers, polyimide-based polymers, polyamide-based polymers, polyalkylene glycol, or copolymers thereof.

7. The composite separator of claim 1, wherein the binder includes polyacrylamide, carboxylmethyl cellulose, or a combination thereof.

8. The composite separator of claim 1, wherein the binder includes carboxymethyl cellulose having a weight-average molecular weight of at least 180,000 and a degree of substitution in a range of 0.6 to 1.2.

9. The composite separator of claim 1, wherein the porous substrate is hydrophilically surface-treated to be hydrophilic.

10. The composite separator of claim 1, wherein the ceramic layer has a coating density in a range of 1.2 to 1.8 g/cm³.

11. The composite separator of claim 1, wherein the ceramic layer has a total thickness in a range of 0.5 μm to 10 μm.

12. The composite separator of claim 1, wherein the composite separator has a thickness in a range of 1 to 100 μm.

13. The composite separator of claim 1, wherein, when the composite separator is subjected to a cardboard test, a ratio of an area occupied by foreign matter smeared on a surface of a cardboard to a total area of the cardboard is 5% or less,
wherein the cardboard test comprises:
placing a black cardboard and a rubber pad having a size of 2 cm×10 cm sequentially on a ceramic layer of a composite separator specimen having a size of 5 cm×10 cm;
pulling the cardboard horizontally at a speed of 0.1 m/s while applying a force of 10 N to the rubber pad using a pressing device; and
evaluating a degree of foreign matter smeared on the surface of the cardboard.

14. The composite separator of claim 1, wherein the composite separator exhibits heat shrinkage rates in machine direction (MD) and transverse direction (TD) of 4% or less, wherein the heat shrinkage rates in MD and TD are measured after the composite separator is allowed to stand at 150° C. for 60 minutes.

15. An electrochemical device comprising a positive electrode, a negative electrode, and a composite separator between the positive and negative electrodes,
wherein the composite separator includes:
a porous substrate; and
a ceramic layer disposed on at least one surface of the substrate, the ceramic layer including inorganic particles and a binder,
wherein the inorganic particles have an average particle diameter (D50) in a range of 0.2 μm to 0.4 μm, and a ratio (A/B) of at least of 1.05, the ratio (A/B) being calculated between an area (A) on a small particle diameter side and an area (B) on a large particle diameter side based on a maximum peak in a particle size distribution diagram of the inorganic particles.

16. The composite separator of claim 15, wherein the inorganic particles have a (D95−D50)/D50 value in a range of 1.8 to 2.5 in the particle size distribution diagram.

17. The composite separator of claim 15, wherein the ratio (A/B) is in a range of 1.05 to 1.3 based on the maximum peak in the particle size distribution diagram of the inorganic particles.

18. The composite separator of claim 15, wherein the ceramic layer has a coating density in a range of 1.2 to 1.8 g/cm³.

19. The composite separator of claim 15, wherein the composite separator exhibits heat shrinkage rates in machine direction (MD) and transverse direction (TD) of 4% or less, wherein the heat shrinkage rates in MD and TD are measured after the composite separator is allowed to stand at 150° C. for 60 minutes.

20. The composite separator of claim 15, wherein the binder includes carboxymethyl cellulose having a weight-average molecular weight of at least 180,000 and a degree of substitution in a range of 0.6 to 1.2.
